(19) United States
(12) Patent Application Publication
(10) Pub. No.: US 2014/0289015 A1
(43) Pub. Date: Sep. 25, 2014

(54) SYSTEMS AND METHODS FOR GAMIFIED AUDIENCE INTERACTION PLATFORM

(71) Applicant: Theresa Y. Lim, San Ramon, CA (US)

(72) Inventor: Theresa Y. Lim, San Ramon, CA (US)

(21) Appl. No.: 14/214,541

(22) Filed: Mar. 14, 2014

Related U.S. Application Data
(60) Provisional application No. 61/786,531, filed on Mar. 15, 2013.

(51) Int. Cl. G06Q 30/02

(52) U.S. Cl. CPC G06Q 30/0203
USPC 705/7.32

(57) ABSTRACT

A computerized method to encourage audience engagement by providing immediate rewards and feedback to audiences as they receive content, the method comprising providing a first content to a user, analyzing a response from the user to the content, wherein the response is selected from a range of options, and analyzing the response to create a second content for the user.

### CROSS REFERENCE TO RELATED APPLICATION

This non-provisional application claims the benefit of provisional application No. 61/786,531 filed on Mar. 15, 2013, entitled “Systems and Methods for Gamified Audience Interaction Platform”, which application and is incorporated herein in its entirety by this reference.

### BACKGROUND

The present invention relates to systems and methods for engaging audiences both online and offline. More specifically, the invention relates to encouraging audience engagement by providing immediate rewards and feedback to audiences as they receive content, as well as providing insights about the audience profile and behavior back to the Brand Owners.

Generally, audience interaction online and offline (events) is challenging due to reasons including poor content, presentation and distractions including email, etc. Brands spend millions of dollars trying to engage with their target audience both online and offline but struggle with both obtaining and measuring their return on investment. Many brands use online surveys to engage with their audiences but participation in these surveys can be low. Some brands use physical audience interaction devices to enable their audiences to vote. Gen X and Y grew up with online games and the increasing popularity of gamification, i.e., the application of game-elements in non-game contexts has also been recently growing.

The proliferation of smartphones means that the tracking of user behaviors (if the user permits) can give brands insights into what customers actually want and how best to engage and reach them.

There is an opportunity to provide a platform to brands to create simple, fun quizzes to engage with their target audience both online and offline, and allow the brands and audience to easily interact about the content shared via social media, provide brands with insights into the users and their behaviors, and promote easy sharing by the initial audience of the content to their network.

### SUMMARY

To achieve the foregoing and in accordance with the present invention, systems and methods for the audience interaction platform.

The user then selects the option(s) that he/she believes is the best answer. For quizzes, the faster the user selects the correct option(s), the higher his/her score. The user can share content with his/her network and can get points for sharing.

The Session Recommendation Engine uses the data available in a user's social media profile and the user's answers to specific questions and rules set up by the Brand Owner to recommend specific session(s) that the user should attend.

The Audience Analytics Platform allows the Brand Owners (who may be the Community Manager, the Event Manager representing a brand like Oracle, EMC, etc.) to mine the data that represent the user behavior in order to generate insights.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a flow diagram showing how the Brand Owner engages with the Audience Interaction Platform, the Session Recommendation Engine and the Audience Analytics Platform interact with the Quiz/Survey & Audience Database, before going through the Wide Area Network to reach the Users on computerized devices such as tablets, mobile phones and desktops;

FIGS. 2A-2E are flow diagrams illustrating one embodiment of the Audience Interaction Platform in accordance with the present invention;

FIGS. 3A-3C are flow diagrams illustrating one embodiment of the Session Recommendation Engine in accordance with the present invention; and

FIGS. 4A-4B are flow diagrams illustrating one embodiment of the Audience Analytics Platform.

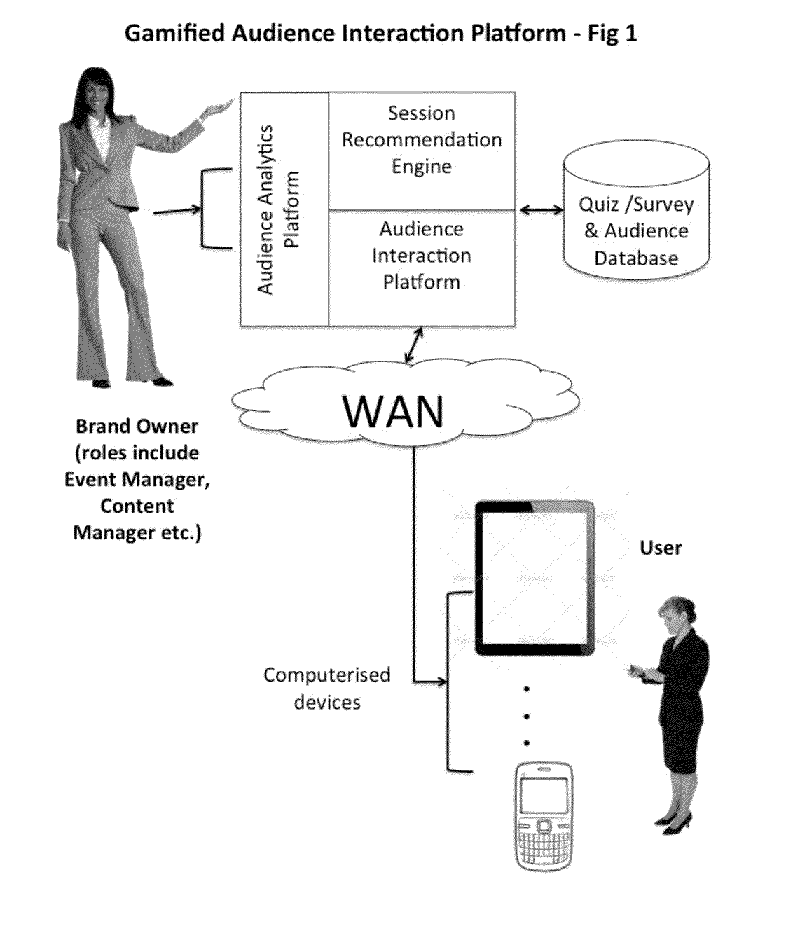

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

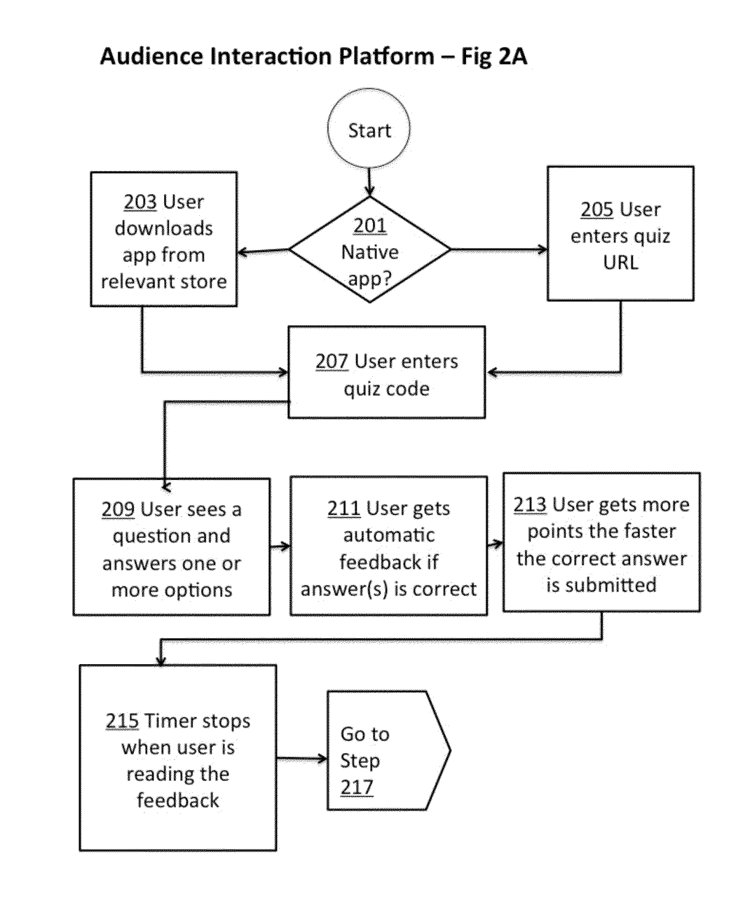

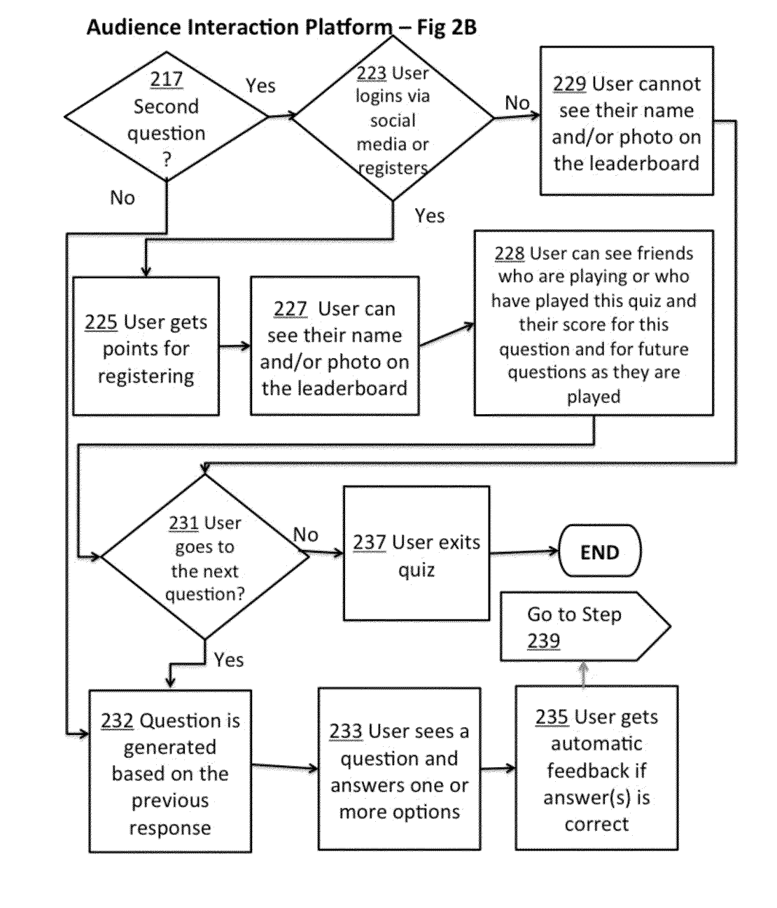

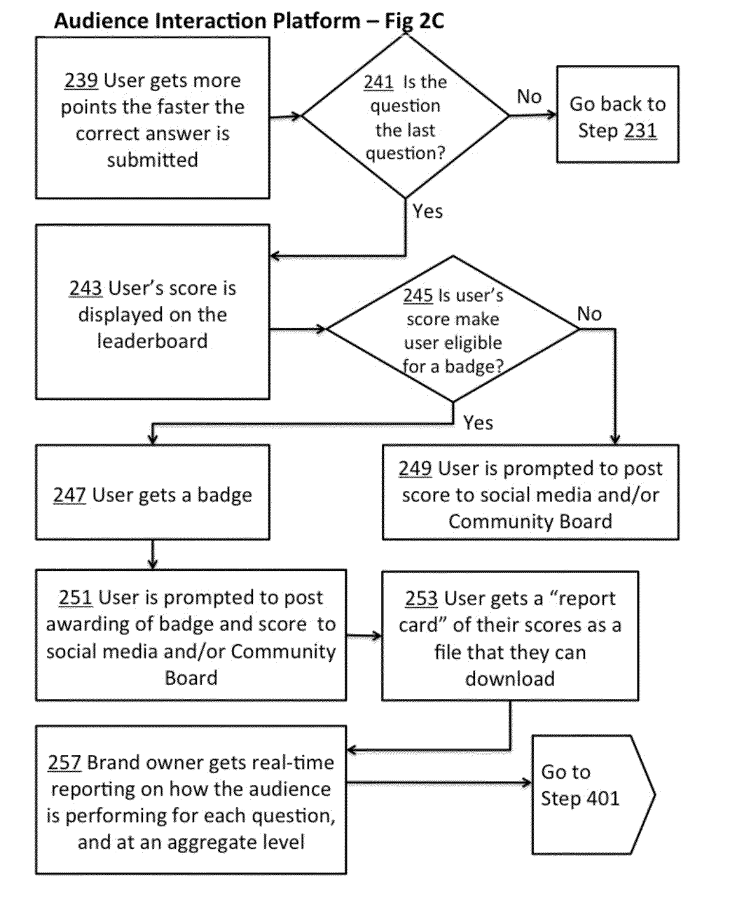

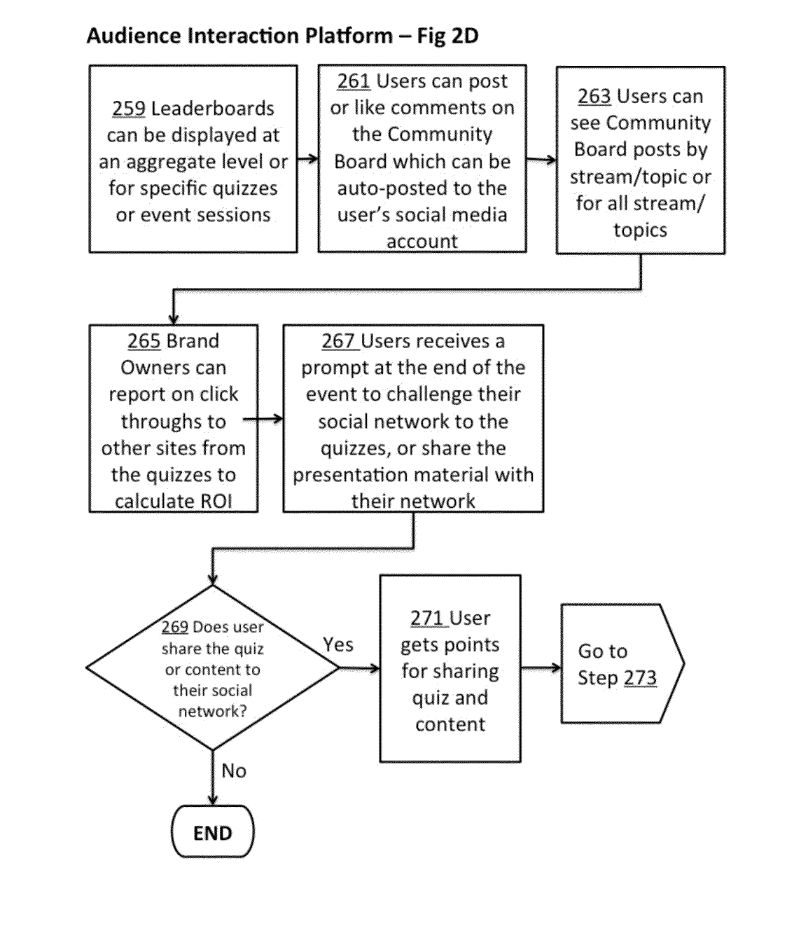

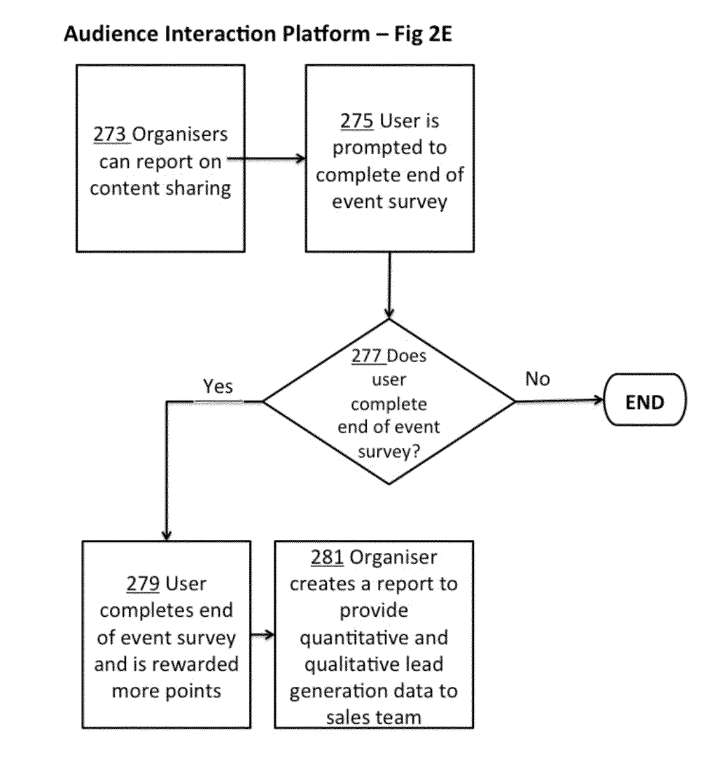

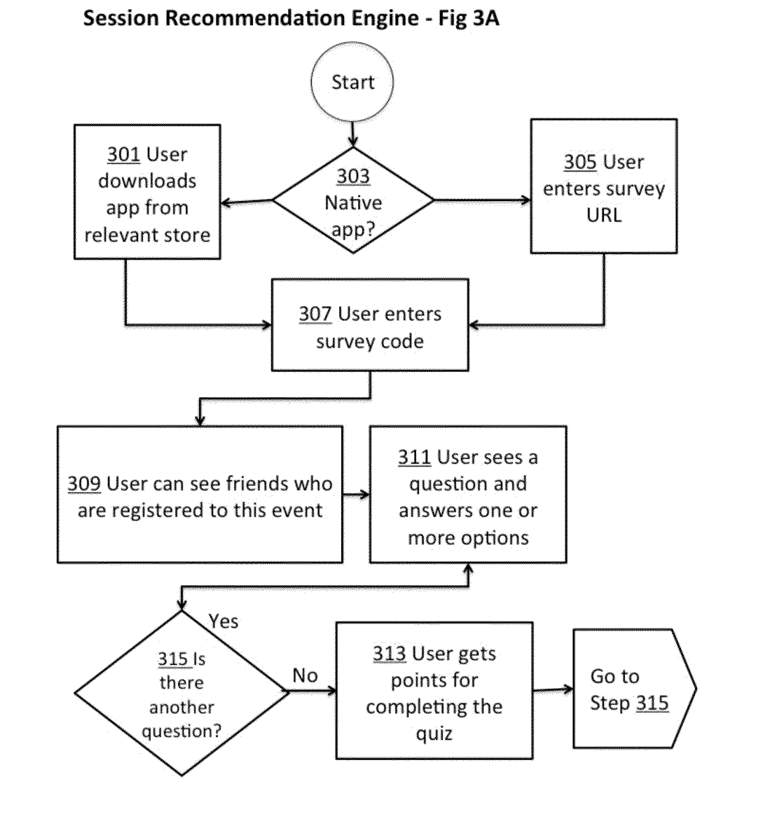

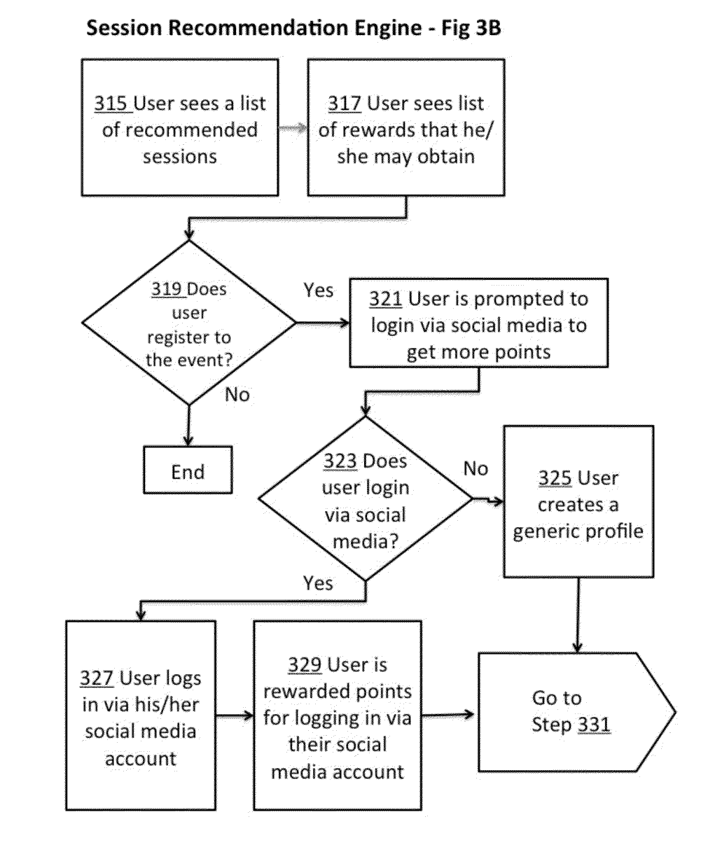

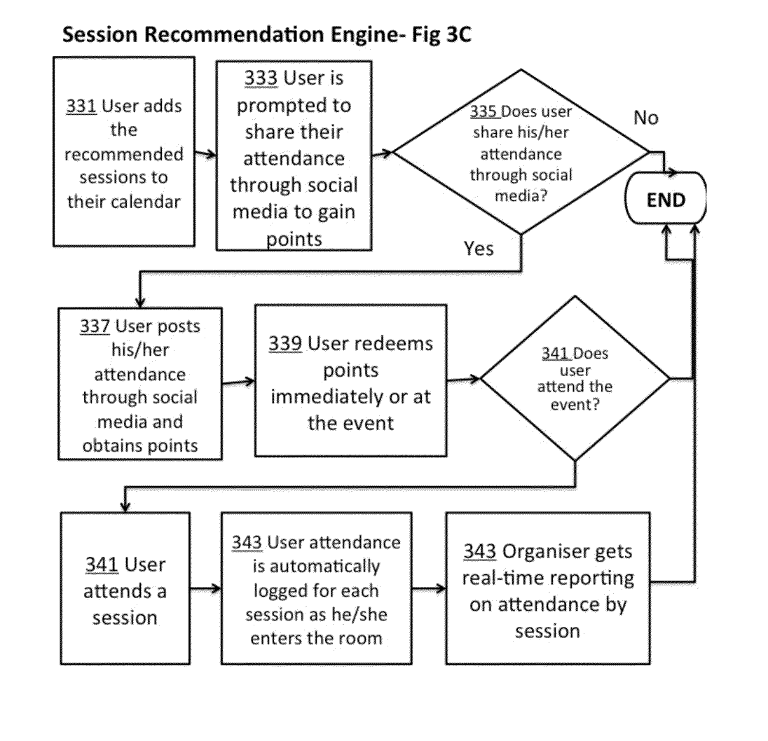

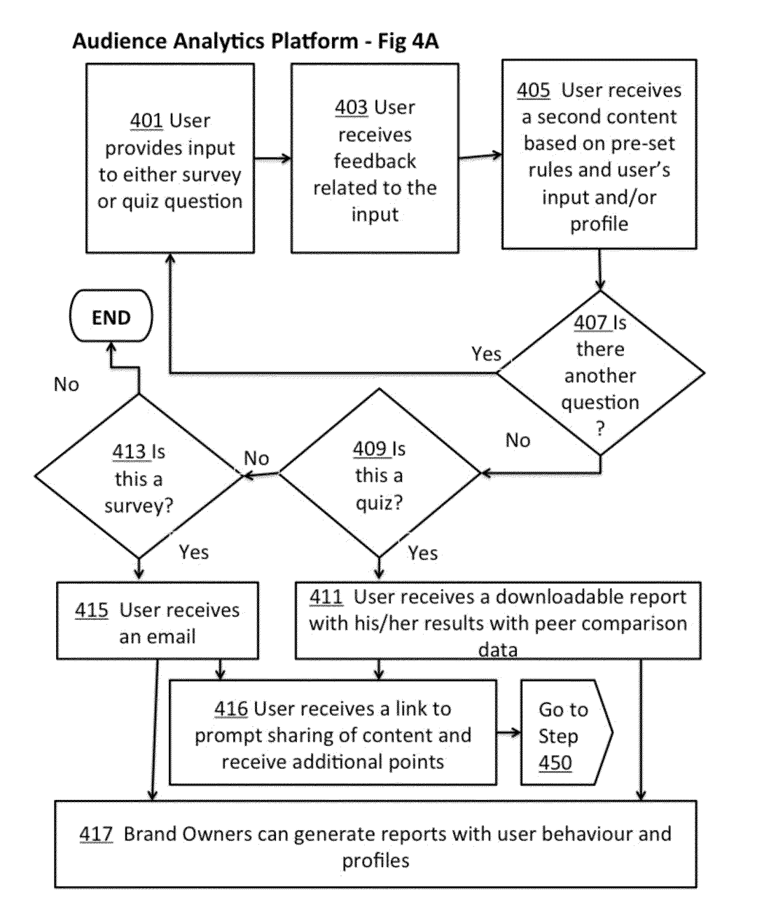

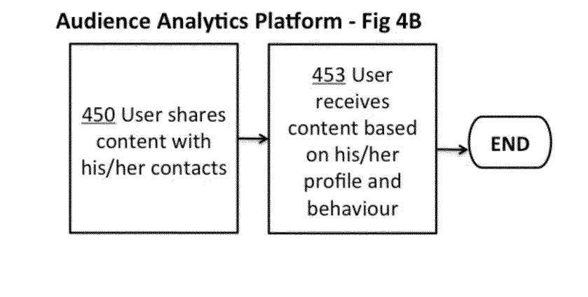

The present invention relates to systems and methods for interacting with audiences both online and offline with a plurality of audience member (herein called “users”). To facilitate discussion, FIGS. 2A-2E are flow diagrams illustrating one embodiment of the audience interaction platform in accordance with the present invention. FIGS. 3A-3C are flow diagrams illustrating one embodiment of the session recommendation engine in accordance with the present invention. FIGS. 4A-4B are flow diagram illustrating one embodiment of the audience analytics platform in accordance with the present invention.

For native apps, the quiz is downloaded as a native app from one of the app stores (e.g., Apple App Store, Google Play etc.) in Step 203. If not a native app, the user enters a quiz URL as shown in step 205.

In step 207, for both native and web based quiz apps, the user may need to enter a quiz code to access the quiz.

In step 209, the user sees the first question and selects one or more options as the answer. User then gets automatic feedback (step 211) if the answer(s) he/she chose is correct. The system then displays the points earned in step 213 (the faster he/she answers the higher the points). The timer stops when user is reading the feedback (step 215).

If there is a second question, user is prompted to login via his/her social media account (e.g., LinkedIn, Twitter) or create a user account (step 223). If there is a photo in the social media account or user, then the user will see his/her name and photo. If user has logged in via his/her social media account, then the user will also be able to see which of his friends/connections who have or are playing the quiz, and their scores for specific questions as each future question is played.

If user continues playing the quiz, each new question is presented to the user based on the previous answer provided (step 232).

As the user gets points, his/her points can be displayed on the leaderboard (step 243). Depending on the total score, the user may also be eligible for a badge (step 245-247). If eligible for a badge, the user will also be prompted to post his/her score(s) to social media and/or the Community Board (step 251).

Leaderboards can display scores for users at an aggregate level (all quizzes for that Brand Owner), for specific quizzes, or for event sessions (step 259).

At the end of the quiz, user can also download a report card to show their scores (step 253).

The Brand Owner gets real-time reporting on how the audience is performing for each question, and at an aggregate level (step 257).

Users can post or “like” comments on the Community Board (step 261). If the user has signed in through his/her social media account, he/she can also auto-post these comments to their social media accounts. Users can see Community Board posts by stream/topic or for all stream/topics (step 263).

Brand Owners can report on click-throughs to other sites from the quizzes to calculate ROI (step 265), content sharing (step 273), as well as qualitative and quantitative lead generation data (step 281).

Users receives a prompt at the end of the event to challenge their social network to the quizzes, or share the presentation material with their social network (step 267). If they do share with their social network, they will get points for sharing (step 271).

If user completes end of event survey, he/she is rewarded more points (step 279).

FIGS. 3A-3C outlines the Session Recommendation Engine which uses the similar systems as the Audience Interaction Platform in FIGS. 2A-2E—i.e. the user is presented same questions to answer, and the Session Recommendation Engine then recommends the session(s) for the user based on the answers he/she provides (Step 331).

User is prompted to share their attendance through social media to gain points (Step 333).

As user attends a session, the user's attendance is automatically logged by the Session Recommendation Engine for each session as he/she physically enters the room (Step 334). Users' attendance can be reported in real time by session for the Brand Owners (Step 343).

The Audience Analytics Platform (FIGS. 4A-4B) allows specific questions to be presented to the user based on the answer the user provides to the previous answer (Steps 401-403). If the user is completing a survey, then the user will receive an email (e.g., to thank the user for completing the survey)—Step 415. If the user is completing a quiz, then the user will receive a downloadable report with comparable peer data (Step 411). For both quizzes and surveys, Brand Owners can generate reports with user behaviors and profiles.

User receives a link to prompt sharing of content and receive additional points (Step 416). If User shares the content (Step 450), the User then receives content based on his/her profile and behavior (Step 453).

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method to encourage audience engagement by providing immediate rewards and feedback to audiences as they receive content, the method comprising:
providing a first content to a user;
analyzing a response from the user to the content, wherein the response is selected from a range of options;
analyzing the response to create a second content for the user; and
wherein the creation of the second content includes varying the difficulty of at least one of scope, subject matter, and call to action.

2. The method of claim 1 wherein the creation of the second content includes creating content for the first user who has shared the content with his/her contacts.

3. The method of claim 1 wherein the provision of the first content to the user precedes provision of feedback to the user wherein the feedback corresponds to the response.

4. The method of claim 1 wherein the analysis of the responses can also result in the ability to generate reports for the brand.

5. A recommendation engine makes recommendations for sessions based on various inputs including:
response from a user obtained through a survey;
demographic profile of an attendee obtained through various inputs including a user profile obtained through their login to the system, social media login or through the survey, or through the potential attendee completing a profile assists in the recommendation of the sessions;
pre-determined rules created by the organizers;
matched potential attendee profile against similar attendees; and
recommendations based on those similar attendees' session choices.
